(19) United States
(12) Patent Application Publication
(10) Pub. No.: US 2008/0133029 A1
(43) Pub. Date: Jun. 5, 2008

(54) Method For Interlinking Technical Data And System For Operating And Observing An Industrial Plant

(76) Inventors: Thomas Heimke, Erlangen (DE); Udo Wellenbrink, Erlangen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/718,948

(22) PCT Filed: Nov. 8, 2005
(86) PCT No.: PCT/EP05/55832

§ 371 Date: Sep. 28, 2007

(30) Foreign Application Priority Data
Nov. 9, 2004 (DE) 10 2004 054 355.0

(51) Int. Cl. G05B 11/01; G06F 17/30

(52) U.S. Cl. 700/2; 707/100; 707/E17.009; 707/E17.011

(57) ABSTRACT

In a method for processing process data of a technical plant, documentation data of the process data stored in different data formats are fed to a documentation generator (7), these documentation data are extracted by means of the documentation generator (7) from associated files and/or tools and converted into at least one standardized format and stored, and these documentation data, stored in at least one standardized format, are interlinked with one another on the basis of semantic aspects and their interlinkage is stored and/or output.

### CROSS-REFERENCE TO RELATED APPLICATIONS

This application is a U.S. national stage application of International Application No. PCT/EP2005/055832 filed Nov. 8, 2005, which designates the United States of America, and claims priority to German application number 10 2004 054 355.0 filed Nov. 9, 2004, the contents of which are hereby incorporated by reference in their entirety.

### TECHNICAL FIELD

The invention relates to a method for interlinking technical data and to a system for operating and observing an industrial plant.

### BACKGROUND

The automation of an industrial plant involves the production of a large number of technical results, known as engineering results. If they are in the form of electronic data, these results are in data formats that are completely different from one another—even if they relate to a single industrial plant. This makes it much more difficult to operate, service and expand the industrial plant.

### SUMMARY

Thus there exists a need to make it easier to operate, service and expand an industrial plant.

According to an embodiment, a method for processing process data of a technical plant, may comprise the steps of feeding documentation data of the process data stored in different data formats to a documentation generator, extracting the documentation data by means of the documentation generator from associated files and/or tools, converting and storing the documentation data into at least one standardized format, and interlinking the documentation data, stored in at least one standardized format, with one another on the basis of semantic aspects and storing and/or outputting the interlinkage.

### BRIEF DESCRIPTION OF THE DRAWINGS

Further advantages and details of the invention are described below by way of example on the basis of the drawings, in which:

FIG. 1 shows an industrial plant with an automation system;

FIG. 2 shows a user interface of an input and output device.

### DETAILED DESCRIPTION

According to an embodiment, in a method for interlinking technical data, in a first step, data for the documentation of an industrial plant and/or engineering results of the industrial plant are transferred into at least one standardized format by means of a documentation generator, and in a second step, the data in the at least one standardized format are interlinked on the basis of semantic aspects.

This interlinkage of the data in the at least one standardized format can be advantageously replicated in the form of navigation paths.

The data, interlinked and in the at least one standardized format, can be advantageously stored as generated plant documentation on a documentation server.

According to another embodiment, a system for operating and observing an industrial plant may comprise at least one input and output device, at least one automation device and a documentation server, on which the generated plant documentation is stored, the at least one input and output device being coupled with the at least one automation device.

The input and output device may advantageously have means for activating the automation device, which means can be linked context-sensitively with the corresponding parts of the generated plant documentation stored on the documentation server.

Considerably faster and less error-prone tracing of fault patterns in the industrial plant, parts thereof or in its automation system is made possible according to different embodiments. Furthermore, targeted expansion of plant automation becomes possible, since the component parts of the industrial plant and of the automation system of the industrial plant can be comprehensively considered along with the ways in which they interact internally and with respect to one another.

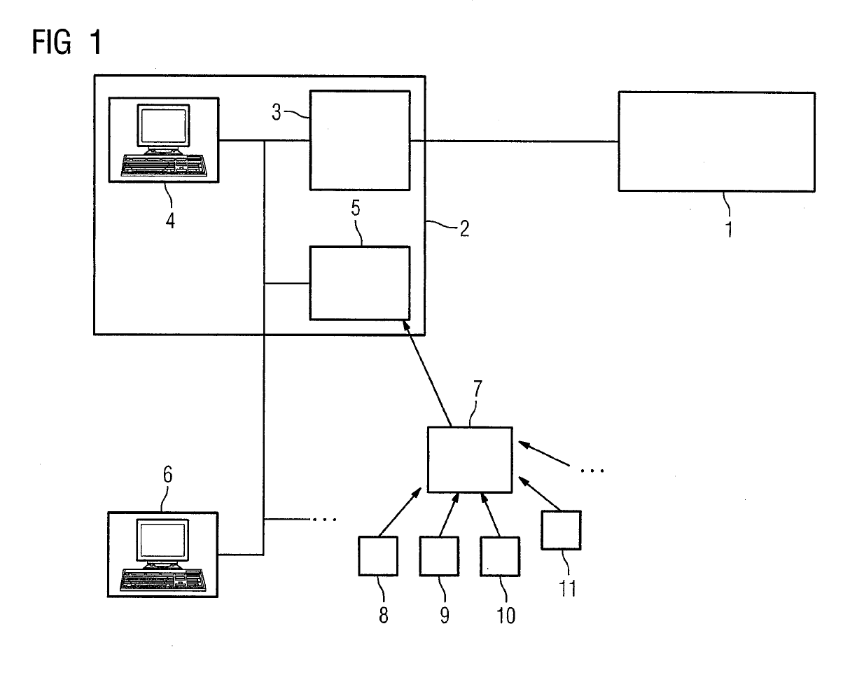

FIG. 1 shows an industrial plant 1 with an automation system 2. The automation system 2 has one or more automation devices 3. The automation device 3 serves for the closed-loop and/or open-loop control of the industrial plant 1. The industrial plant 1 is accordingly coupled with the automation system 2. The automation system 2 has at least one input and output device 4. The input and output device 4 is preferably used for operating and observing the industrial plant 1 or the automation system 2.

Engineering results are generally initially stored on different data carriers 8 to 11, a number of different data formats being used for different engineering results. The data carriers 8 to 11 are preferably electronic data carriers, such as for example CD-ROMs. A data carrier 8 to 11 may, however, also be a module, for example an automation device 3. On the data carriers 8 to 11, engineering results are stored as original data, for example as a file in pdf format, as an AutoCAD drawing, or for example also as a standard file of an application program of a personal computer, for example in Microsoft Office format. On a data carrier 8 to 11, data may also be stored in various proprietary formats of engineering tools, for example Sigraph or SIMATIC PCS 7. Engineering results stored on one or more data carriers 8 to 11 are also, for example, schematic circuit diagrams, CAD documents, plant layouts and software plans.

According to an embodiment, the data carriers 8 to 11 with the original data, i.e. the engineering data and/or data for plant documentation in the different data formats, are fed to a documentation generator 7. The documentation generator 7 has corresponding interfaces, in order to extract the data stored on the data carriers 8 to 11 in the different data formats automatically from documentation and engineering tools and transfer them into a standardized format. One of the effects achieved by this is independence from the engineering tools originally used and availability of the latter whenever access to plant-specific data for operating, servicing and/or expanding the plant is concerned. One or more of the following formats is used as the standardized format: XML or HTML, SVG (scaleable vector graphics), CGM (computer graphics metafile). Original data, for example in the Microsoft Office format or in pdf format, are preferably transferred by means of the documentation generator 7 into an XML or HTML format, data such as schematic circuit diagrams, CAD documents, software plans and plant layouts are preferably transferred into SVG or CGM.

In the documentation generator 7, the data transferred into a standardized format, that is to say a standard format for the generated data, are interlinked with one another on the basis of semantic aspects. Intelligent algorithms are preferably used for the interlinkage. The interlinkages are replicated by navigation paths between the data in the standard format.

The data transferred into the standard format and interlinked by means of the documentation generator 7 are stored as so-called generated plant documentation. The generated plant documentation is preferably stored on a document server 5. As shown in FIG. 1, the documentation server 5 may preferably be integrated in the automation system 2. The generated plant documentation can be accessed by means of the at least one input and output device 4 of the automation system 2. Further end devices 6 may be provided, with the aid of which the generated plant documentation stored on the documentation server 5 can be accessed. End devices 6 may be, for example: computing units with display and input devices, such as for example personal computers, which are installed inside the industrial plant 1 or in the vicinity of the industrial plant 1.

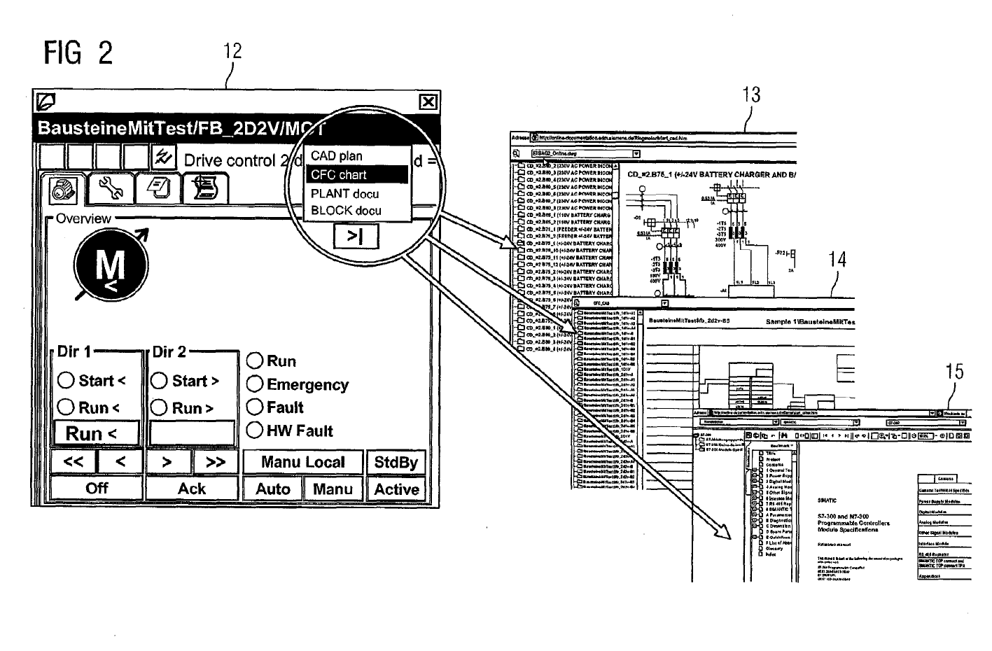

FIG. 2 shows by way of example a user interface 12 of an input and output device 4. The generated plant documentation is provided on the documentation server 5 (see FIG. 1) in such a way that the generated plant documentation can be accessed context-sensitively from the user interface 12 of the input and output device 4. The input and output device 4 (see FIG. 1) preferably has a visualization system, for example WinCC, and is coupled with one or more automation devices 3. The user interface 12 has context-sensitive operating elements, preferably for the industrial plant 1. With the aid of so-called active control technology (OCX technology or so-called “Active X Controls”), an interlinkage to the generated plant documentation is respectively assigned to one or more operating elements of the user interface 12. Depending on the meaning of the operating element of the user interface 12, it is possible for example to generate a menu, which establishes a link to one or more relevant parts of the generated plant documentation. For example, a link can be established to an operating element implemented on the user interface 12, for example to a valve of the industrial plant 1, for example directly to a software plan with implementation contents for activating the valve, to a schematic circuit diagram with the installation location of the valve, to an OEM manual for this valve, setting instructions for this valve and/or other parts 13 to 15 of the generated plant documentation.

In FIG. 2, the interlinkage to various parts 13 to 15 of the generated plant documentation is shown by way of example. The parts 13 to 15 of the generated plant documentation are, for example, a hardware engineering or CAD plan (part 13), a software engineering or CFC plan (part 14) or equipment documentation (part 15). According to an embodiment, the context-sensitive navigation to operation-relevant detailed information is made possible by the plant documentation generated by means of the documentation generator 7. Navigation between the various parts 13 to 15 of the generated installation documentation is preferably also made possible. According to an embodiment, easy navigation between software realization on the one hand and corresponding hardware engineering on the other hand of component parts of an industrial plant 1 and/or its automation system 2 is also made possible.

According to an embodiment, it is also possible to superpose current process data of the industrial plant 1 on parts 13 to 15 of the plant documentation generated by means of the documentation generator 7, for example input data of module connectors on the corresponding part 14 of the generated plant documentation. The generated plant documentation is in this way made dynamic and preferably actively coupled with the industrial plant 1, which is preferably in operation. For example, it is also possible to superpose current process data on software plans for example, to provide a service or development engineer with a better overview during the operating phase of an industrial plant 1.

It is also possible to access the generated plant documentation, preferably also the plant documentation made dynamic, from various end devices 6. End devices 6 may also be mobile end devices, such as for example PDAs (Personal Digital Assistants), cell phones or portable computing units such as notebooks or tablet PCs. Mobile end devices of this type can be used at least to a limited extent for controlling the industrial plant 1.

In summary according to the different embodiments, a method interlinks technical data, in particular interlinks hardware and software engineering data as well as additional documents, for a web-based visualization of industrial plant documentation with the aid of a documentation generator 7. Also, a system for operating and observing an industrial plant 1 comprises at least one input and output device 4, 6, at least one automation device 3 and a documentation server 5, on which the plant documentation generated with the aid of the documentation generator 7 is stored.

What is claimed is:

1. A method for processing process data of a technical plant, the method comprising the steps of:
feeding documentation data of the process data stored in different data formats to a documentation generator,
extracting the documentation data by means of the documentation generator (7) from associated files and/or tools, converting and storing the documentation data into at least one standardized format,
interlinking these documentation data, stored in at least one standardized format, with one another on the basis of semantic aspects and storing and/or outputting the interlinkage.

2. The method according to claim 1, wherein the interlinkage of the data in at least one standardized format is replicated in the form of navigation paths.

3. The method according to claim 1, wherein the documentation data which are in at least one standardized format and which are interlinked are stored as generated plant documentation on a documentation server.

4. A device for processing process data of a technical plant, comprising:
a documentation generator, to which documentation data of the process data stored in different data formats is fed and which extracts these documentation data from the associated files and/or tools and converts them into at least one standardized format and, on the basis of semantic aspects, interlinks the documentation data converted into a standardized format with one another and stores and outputs their interlinkage.

5. A method of using a device for processing process data of a technical plant according to claim 4 in a system for operating and observing an industrial plant comprising at least one input and output device for acquiring and outputting the process data, at least one automation device for the open-loop and/or closed-loop control of the plant on the basis of the process data, and a documentation server, which are coupled with one another, and wherein at least the documentation server is coupled with the documentation generator and the documentation generators is fed documentation data of the process data stored in different data formats, the method comprising the steps of:
converting the documentation data into a standardized format and interlinking the documentation data with one another on the basis of semantic aspects and transfering these converted and interlinked documentation data to the documentation server by the documentation generator, wherein the converted and interlinked documentation data is stored in the form of plant documentation in the documentation server.

6. The method according to claim 5, wherein the input and output device has means for activating the automation device, which means can be linked context-sensitively with the corresponding parts of the generated plant documentation stored on the documentation server.

7. A system for processing process data of a technical plant, comprising:
a documentation generator receiving documentation data of the process data stored in different data formats, wherein the documentation generator is operable to extract the documentation data from associated files and/or tools, to convert and to store the documentation data into at least one standardized format, and
means for interlinking the documentation data, stored in at least one standardized format, with one another on the basis of semantic aspects and storing and/or outputting the interlinkage.

8. The system according to claim 7, wherein the interlinkage of the data in at least one standardized format is replicated in the form of navigation paths.

9. The system according to claim 7, further comprising a documentation server for storing the documentation data which are in at least one standardized format and which are interlinked as generated plant documentation.
